(19) United States
(12) Patent Application Publication
(10) Pub. No.: US 2008/0030942 A1
(43) Pub. Date: Feb. 7, 2008

(54) Folding Electronic Device

(76) Inventor: Luis E. Elizalde, Durham, NC (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/462,119

(22) Filed: Aug. 3, 2006

(51) Int. Cl. G06F 1/16

(52) U.S. Cl. 361/683; 361/679

(57) ABSTRACT

A folding electronic device includes first and second housing bodies mounted for pivotal movement relative to each other between first and second configurations. At least one hollow flexible elastic hinge has first and second ends fixedly attached to the first and second bodies, respectively. Each hinge expands as the bodies pivot toward the first configuration and contracts as the bodies pivot toward the second configuration. In accordance with the preferred embodiments, the hinges comprise a pair of elastic fabric tubes advantageously having near-zero tolerance, and a flexible wiring ribbon extends through each tube and is free to slide therein as the tube expands and contracts. Also in accordance with the preferred embodiments, user controls on the first body and a display screen on the second body are exposed in an open configuration and covered in a closed configuration, and in both configurations the bodies are oriented and secured wall-to-wall.

### BACKGROUND OF THE INVENTION

1. Field of Invention

The present invention relates in general to the field of portable electronic devices. More particularly, the present invention relates to a folding electronic device that incorporates a hollow flexible elastic hinge.

2. Background Art

Portable electronic devices, such as digital audio players, portable electronic game devices, cell phones, pagers, PDAs (personal data assistant), laptop and notebook computers, tablet computers, and portable computers, often are provided with hinge mechanisms that allow one housing body to pivot with respect to another housing body. The hinge mechanism typically allows the portable electronic device to be folded into a closed configuration during periods of non-use to reduce the size of the device and to protect components such as a display screen and input buttons. However, conventional hinge mechanisms add volume, weight and complexity to the portable electronic device. These disadvantages conflict with the ever increasing demands for product miniaturization and minimalist approaches.

FIGS. 1-3 show various views of a portable digital audio player 100 having a clamshell design that incorporates a conventional hinge mechanism 102. FIG. 1 is a front, right perspective view of digital audio player 100 in an open configuration. FIG. 2 is a right-side elevational view of digital audio player 100 in the open configuration. FIG. 3 is a right-side elevational view of digital audio player 100 in a closed configuration. As best seen in FIG. 1, digital audio player 100 includes a first housing body 104 having a display screen 106 and a second housing body 108 having user input buttons 110. The first housing body 104 pivots relative to the second housing body 108 via the conventional hinge mechanism 102 between an open configuration (shown in FIGS. 1 and 2) and a closed configuration (shown in FIG. 3). The conventional hinge mechanism 102 is effective in reducing the size of digital audio player 100 when in the closed position, as well as protecting display screen 106 and user input buttons 110. However, the conventional hinge mechanism 102 disadvantageously adds volume, weight and complexity to digital audio player 100. Space savings and simplicity of design have become priority issues when designing portable electronic devices, such as digital audio player 100. Thus, conventional hinge mechanisms present a tradeoff that is less than optimal.

A need exists for an enhanced hinge mechanism for portable electronic devices that substantially overcomes the disadvantages of conventional hinge mechanisms.

### SUMMARY OF THE INVENTION

According to the preferred embodiments of the present invention, a folding electronic device includes first and second housing bodies mounted for pivotal movement relative to each other between first and second configurations. At least one hollow flexible elastic hinge has first and second ends fixedly attached to the first and second bodies, respectively. Each hinge expands as the bodies pivot toward the first configuration and contracts as the bodies pivot toward the second configuration. According to the preferred embodiments of the present invention, the hinges comprise a pair of elastic fabric tubes advantageously having near-zero tolerance, and a flexible wiring ribbon extends through each tube and is free to slide therein as the tube expands and contracts. Also according to the preferred embodiments of the present invention, user controls on the first body and a display screen on the second body are exposed in an open configuration and covered in a closed configuration, and in both configurations the bodies are oriented and secured wall-to-wall.

### BRIEF DESCRIPTION OF THE DRAWINGS

The preferred exemplary embodiments of the present invention will hereinafter be described in conjunction with the appended drawings, where like designations denote like elements.

FIG. 1 is a front, right perspective view of a digital audio player having a clamshell design that incorporates a conventional hinge mechanism, in an open configuration.

FIG. 2 is a right-side elevational view of the digital audio player shown in FIG. 1, in the open configuration.

FIG. 3 is a right-side elevational view of the digital audio player shown in FIG. 1, in a closed configuration.

FIG. 4 is a front, right perspective view of an digital audio player that incorporates a hollow flexible elastic hinge in accordance with the preferred embodiments of the present invention, in an open configuration.

FIG. 5 is a top plan view of the digital audio player shown in FIG. 4 that incorporates a hollow flexible elastic hinge in accordance with the preferred embodiments of the present invention, in the open configuration.

FIG. 6 is a left-side elevational view of the digital audio player shown in FIG. 4 that incorporates a hollow flexible elastic hinge in accordance with the preferred embodiments of the present invention, in the open configuration.

FIG. 7 is a front-side elevational view of the digital audio player shown in FIG. 4 that incorporates a hollow flexible elastic hinge in accordance with the preferred embodiments of the present invention, in the open configuration.

FIG. 8 is a front, right perspective view of the digital audio player shown in FIG. 4 that incorporates a hollow flexible elastic hinge in accordance with the preferred embodiments of the present invention, in a closed configuration.

FIG. 9 is a right-side cross-sectional view of the digital audio player shown in FIG. 4 that incorporates a hollow flexible elastic hinge in accordance with the preferred embodiments of the present invention, in the open configuration.

FIG. 10 is a right-side cross-sectional view of the digital audio player shown in FIG. 4 that incorporates a hollow flexible elastic hinge in accordance with the preferred embodiments of the present invention, transitioning between the open configuration and the closed configuration.

FIG. 11 is a right-side cross-sectional view of the digital audio player shown in FIG. 4 that incorporates a hollow flexible elastic hinge in accordance with the preferred embodiments of the present invention, in the closed configuration.

### DETAILED DESCRIPTION OF THE PREFERRED EMBODIMENTS

1. Overview

In accordance with the preferred embodiments of the present invention, a folding electronic device includes first and second housing bodies mounted for pivotal movement relative to each other between first and second configurations. At least one hollow flexible elastic hinge has first and second ends fixedly attached to the first and second bodies, respectively. Each hinge expands as the bodies pivot toward the first configuration and contracts as the bodies pivot toward the second configuration. In accordance with the preferred embodiments of the present invention, the hinges comprise a pair of elastic fabric tubes advantageously having near-zero tolerance, and a flexible wiring ribbon extends through each tube and is free to slide therein as the tube expands and contracts. Also in accordance with the preferred embodiments of the present invention, user controls on the first body and a display screen on the second body are exposed in an open configuration and covered in a closed configuration, and in both configurations the bodies are oriented and secured wall-to-wall.

2. Detailed Description

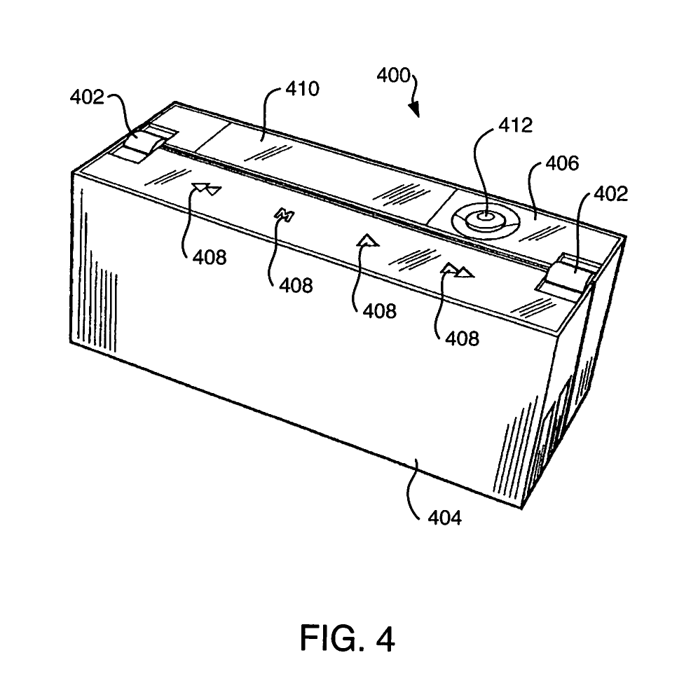

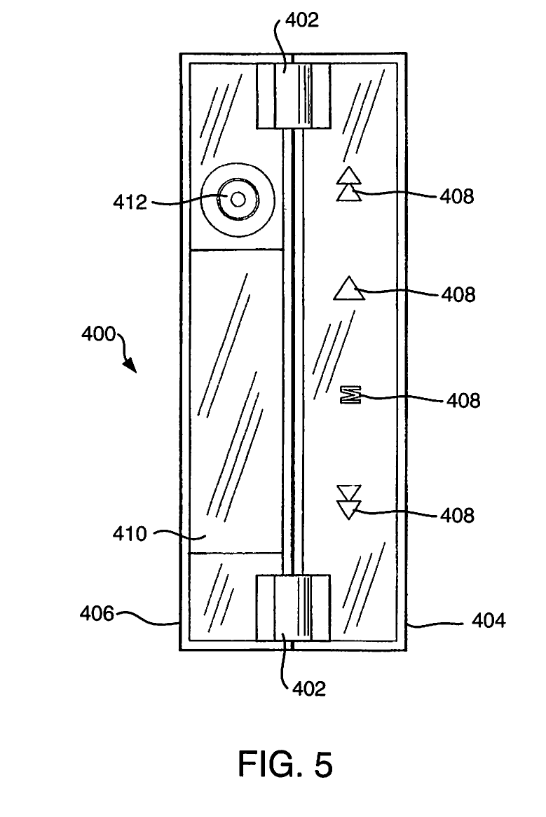

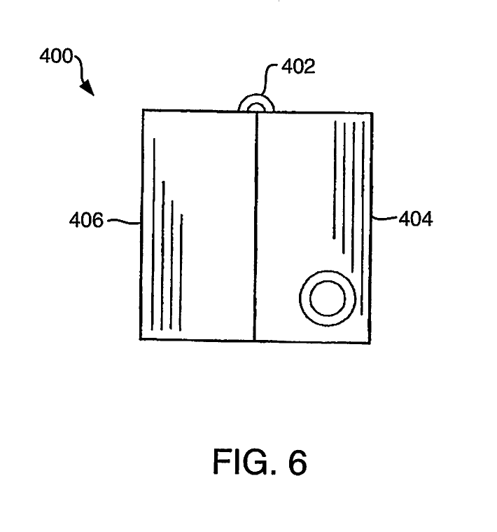

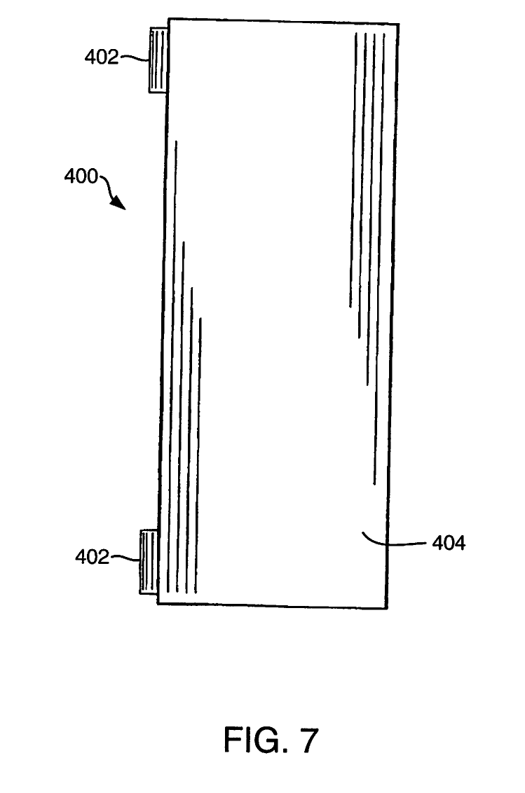

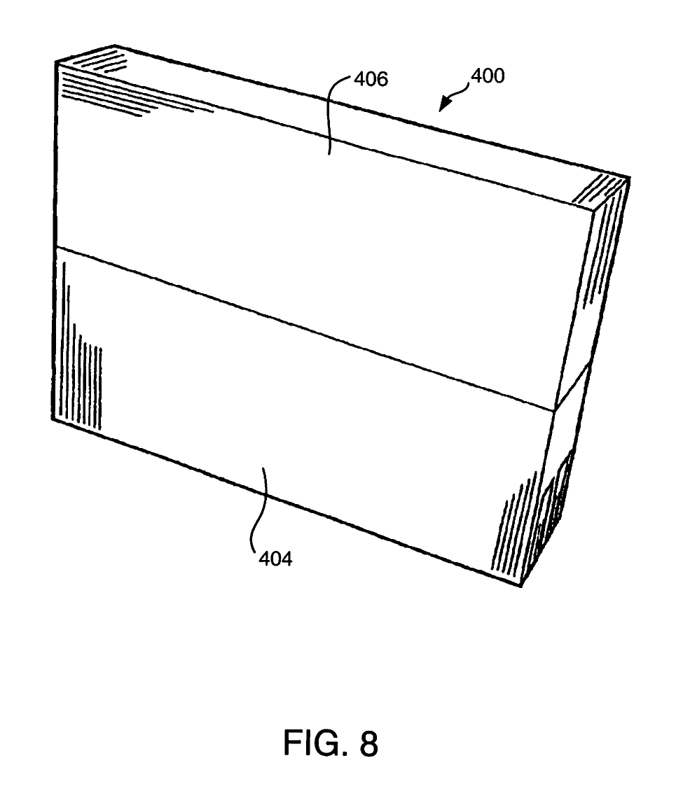

Referring to FIGS. 4-8 there are depicted various external views of a portable audio player 400 having a pair of hollow flexible elastic hinges 402 in accordance with the preferred embodiments of the present invention. FIG. 4 is a front, right perspective view of digital audio player 400 in an open configuration. FIG. 5 is a top plan view of digital audio player 400 in the open configuration. FIG. 6 is a left-side elevational view of digital audio player 400 in the open configuration. FIG. 7 is a front-side elevational view of digital audio player 400 in the open configuration. FIG. 8 is a front, right perspective view of digital audio player 400 in a closed configuration.

Preferably, digital audio player 400 includes two hollow flexible elastic hinges 402. One skilled in the art will appreciate, however, that any number of hollow flexible elastic hinges in accordance with the preferred embodiments of the present invention may be used.

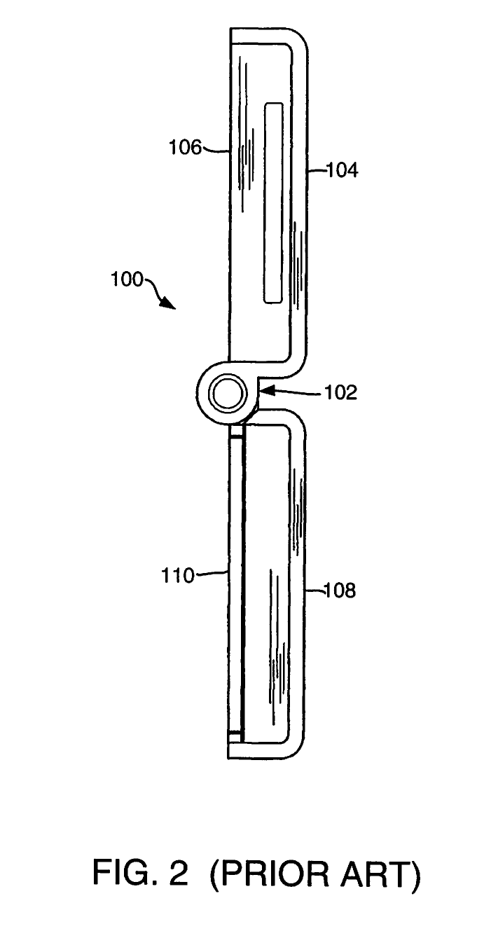

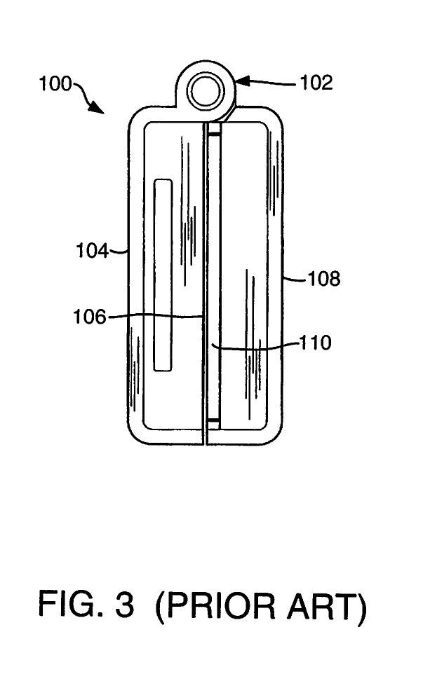

In the preferred embodiments as shown in FIGS. 2-8, hollow flexible elastic hinges 402 are utilized in the context of a particular electronic device, i.e., digital audio player 400. However, digital audio player 400 is merely illustrative. One skilled in the art will appreciate that hollow flexible elastic hinges in accordance with the preferred embodiments of the present invention may be applied in the context of other digital audio devices and other folding electronic devices such as cell phones, pagers, portable electronic game devices, PDAs (personal data assistant), laptop and notebook computers, tablet computers, and portable computers. In addition, one skilled in the art will appreciate that hollow flexible elastic hinges in accordance with the preferred embodiments of the present invention are also applicable to folding electronic devices that are not portable, such as server computer systems and data storage systems with enclosures having one or more pivoting covers that pivot between a closed configuration for normal operation and an open configuration for maintenance.

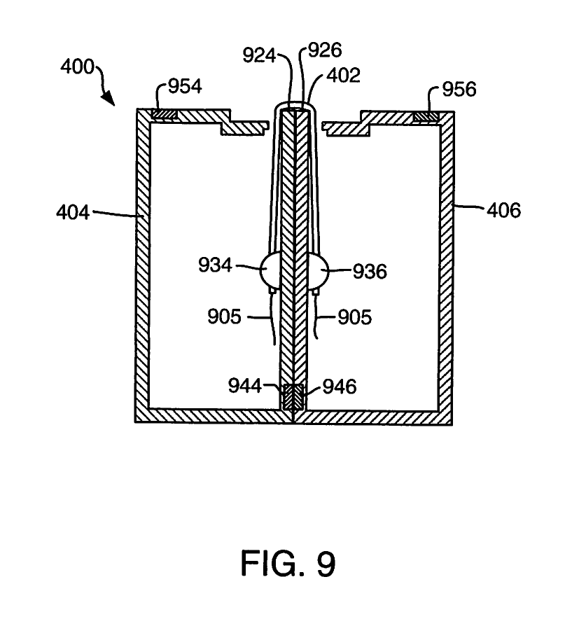

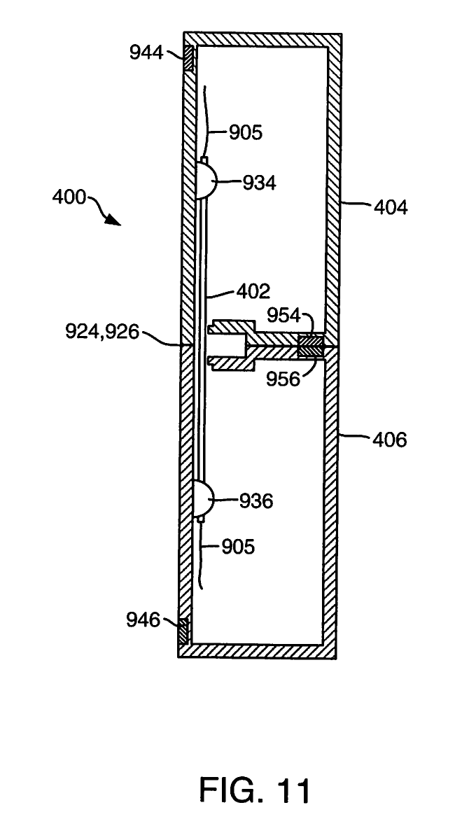

In accordance with the preferred embodiments of the present invention, a folding electronic device, such as portable audio player 400, includes a first housing body 404 and a second housing body 406 mounted for pivotal movement relative to each other between a first configuration (shown in FIGS. 4-7) and a second configuration (shown in FIG. 8). As discussed in detail below with reference to the cross-sectional views of FIG. 9-11, each hollow flexible elastic hinge 202 has a first end fixedly attached to first housing body 404 and a second end fixedly attached to second housing body 406. Each hollow flexible elastic hinge 202 expands as housing bodies 404,406 pivot toward the first configuration (shown in FIGS. 4-7 and 9) and contracts as housing bodies 404,406 pivot toward the second configuration (shown in FIGS. 8 and 11).

As best seen in FIGS. 4 and 5, in accordance with the preferred embodiments of the present invention, first housing body 404 includes one or more user controls 408 (e.g., buttons for play, fast forward, fast reverse, and menu) and second housing body 406 includes a display screen 410. In addition, second housing body 406 may include one or more user controls 412 (e.g., an on/off switch and a button for menu selection). User controls 408, display screen 410 and user controls 412 are exposed in the first configuration (i.e., the “open configuration” shown in FIGS. 4-7 and 9) and covered in the second configuration (i.e., the “closed configuration” shown in FIGS. 8 and 11). In both configurations first housing body 404 and second housing body 406 are preferably oriented wall-to-wall with respect to one another, and, as discussed in detail below with reference to FIGS. 9-11, are secured in this wall-to-wall relationship by one or more fastening devices, such as magnetic fasteners, hook-and-loop fasteners, mechanical latches, etc.

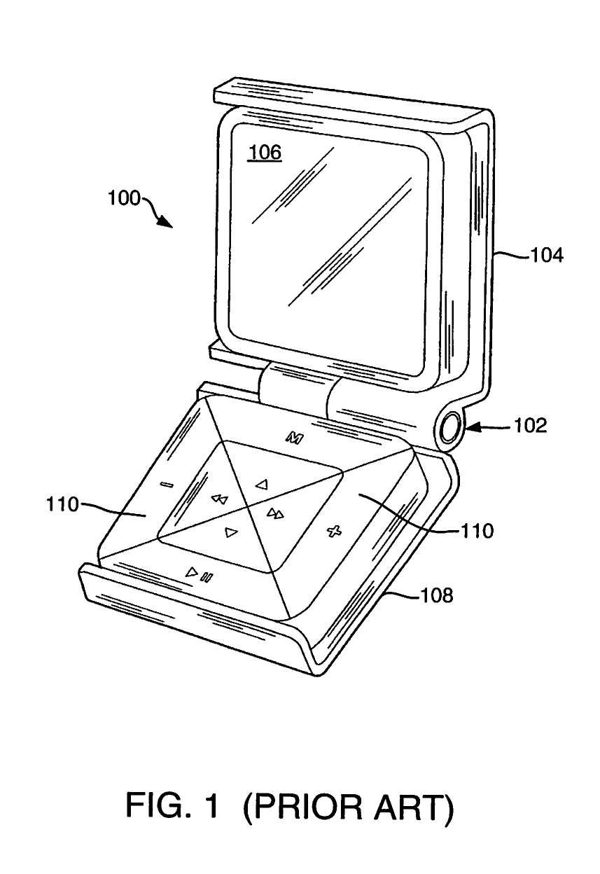

In accordance with the preferred embodiments of the present invention, hollow flexible elastic hinges 202 comprise a pair of elastic fabric tubes advantageously having near-zero tolerance. Accordingly, as best seen in FIGS. 4-7 and 9, hollow flexible elastic hinges 202 preferably protrude only slightly, if at all, from the end surfaces of first housing body 404 and second housing body 406 when digital audio player 100 is in the open configuration. Also, as best seen in FIGS. 8 and 11, hollow flexible elastic hinges 202 are preferably hidden from view when digital audio player 100 is in the closed configuration. The near-zero tolerance of hollow flexible elastic hinges 202 is highly advantageous over conventional hinge mechanisms, such as the conventional hinge mechanism 102 shown in FIGS. 1-3, which protrude to a great extent from the housing bodies in both the open end closed configurations.

As discussed in detail below with reference to FIGS. 9-11, one or more wires and/or a flexible wiring ribbon extend(s) through each tube and is/are free to slide therein as the tube expands and contracts. This wire and/or flexible wiring ribbon connects electronic components in first housing body 404 to electronic components in second housing body 406.

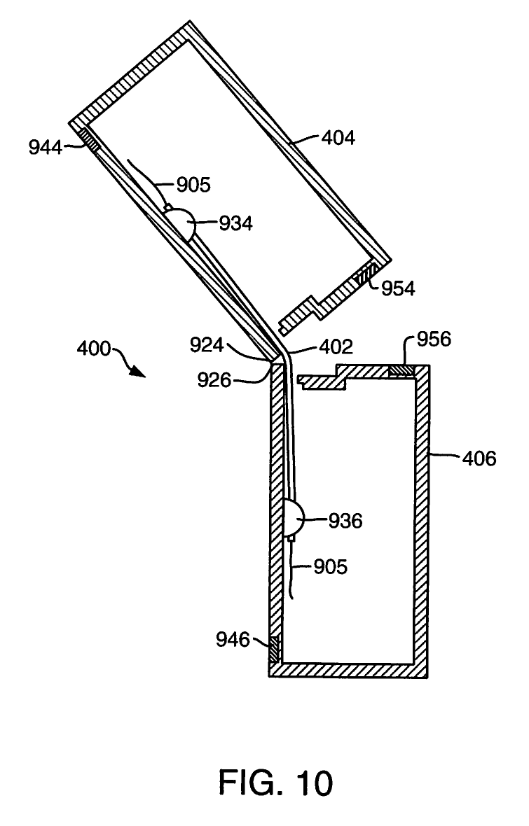

Referring now to FIGS. 9-11 there are depicted various cross-sectional views of a portable audio player 400 having a pair of hollow flexible elastic hinges 402 in accordance with the preferred embodiments of the present invention. FIG. 9 is a right-side cross-sectional view of digital audio player 400 in the open configuration. FIG. 10 is a right-side cross-sectional view of digital audio player 400 transitioning between the open configuration and the closed configuration. FIG. 11 is a right-side cross-sectional view of digital audio player 400 in the closed configuration.

As mentioned earlier, each hollow flexible elastic hinge 402 expands and contracts as housing bodies 404,406 pivot relative to one another. In addition to being hollow, flexible and elastic, each hinge 402 is preferably made of a material that has a suitably low coefficient of friction so as to reduce the likelihood that hinge 402 will “catch” on the surface of the housing bodies 404,406 as housing bodies 404,406 pivot between the first orientation and the second orientation. Each hollow flexible elastic hinge 402 may be, for example, an elastic fabric tube (e.g., a “sock like” tube of woven soft cotton/elastic material). However, one skilled in the art will recognize that other materials, such as rubber and other polymer materials, may be used in the construction of hollow flexible elastic hinge 402.

Each hollow flexible elastic hinge 402 has a first end fixedly attached to first housing body 404 and a second end fixedly attached to second housing body 406. This attachment may be either direct or indirect. The ends of hollow flexible elastic hinge 402 may be, for example, adhered directly to housing bodies 404,406 using an adhesive, such as adhesive blobs 934,936 shown in FIGS. 9-11. However, adhesive blobs 934,936 are merely illustrative. One skilled in the art will appreciate that the ends of hollow flexible elastic hinges 402 may be attached to housing bodies 404,406 using any conventional fastening mechanism, such as screws, staples, rivets, tape, brackets, etc. Moreover, in an alternative embodiment, the ends of hollow flexible elastic hinge 402 may be fixedly attached indirectly to housing bodies 404,406, for example, through being adhered directly to circuit boards mounted within housing bodies 404,406.

As mentioned above, at least one wire 905 and/or a flexible wiring ribbon (not shown) extends through each hollow flexible elastic hinge 402, and is/are free to slide within hinge 402 as hinge 402 expands and contracts in response to housing bodies 404,406 pivoting between the open and closed configurations. Hence, the fastening mechanism by which the ends of hollow flexible elastic hinges 402 are attached to housing bodies 404,406 must not interfere with the ability of the one or more wires 905 and/or flexible wiring ribbon to slide within hinge 402 as hinge 402 expands and contracts. Wire(s) 905 and/or flexible wiring ribbon connect electronic components (not shown) in first housing body 404 to electronic components (not shown) in second housing body 406, and are connected to those electronic components with enough slack to accommodate the sliding movement of wire(s) 905 and/or flexible wiring ribbon relative to the ends of hollow flexible elastic hinges 402.

Housing bodies 404,406 each include a pivot edge surface about which housing bodies 404,406 pivot relative to one another. As shown in FIGS. 9-11, first housing body 404 includes a pivot edge surface 924 and second housing body 406 includes a pivot edge surface 926. Because each hollow flexible elastic hinge 402 extends over pivot edge surfaces 924,926, each hollow flexible elastic hinge 202 expands as housing bodies 404,406 pivot toward the open configuration (shown in FIG. 9) and contracts as housing bodies 404, 406 pivot toward the closed configuration (shown in FIG. 11). When housing bodies 924,926 are in the open configuration as shown in FIG. 9, each hollow flexible elastic hinge 402 makes contact with pivot edge surface 924,926. As best seen in FIG. 10, pivot edge surfaces 924,926 contact one another when housing bodies 404,406 are pivoting between the open configuration (shown in FIG. 9) and the closed configuration (shown in FIG. 11).

Preferably, housing bodies 404,406 include a fastening device that releasable retains housing bodies 404,406 substantially in a wall-to-wall relationship in at least one of the open configuration (shown in FIG. 9) and the closed configuration (shown in FIG. 11). Fastening devices, such as magnetic fasteners, hook-and-loop fasteners, mechanical latches, etc., may be used for this purpose. For example, magnets 944,946 may be respectively mounted to housing bodies 404,406 to secure housing bodies in a wall-to-wall relationship at the open configuration (as shown in FIG. 9), and magnets 954,956 may be respectively mounted to housing bodies 404,406 to secure housing bodies in a wall-to-wall relationship at the closed configuration (as shown in FIG. 11).

One skilled in the art will appreciate that many variations are possible within the scope of the present invention. For example, a pair of hollow flexible elastic hinges is used in the preferred embodiments. One skilled in the art will appreciate, however, that any number of hollow flexible elastic hinges may be used within the scope of the present invention. Also, in the preferred embodiments, hollow flexible elastic hinges are utilized in the context of a particular digital audio player. However, one skilled in the art will appreciate that hollow flexible elastic hinges may be applied within the scope of the present invention in the context of other folding electronic devices such as cell phones, pagers, portable electronic game devices, PDAs (personal data assistant), laptop and notebook computers, tablet computers, portable computers and other digital audio devices. In addition, one skilled in the art will appreciate that hollow flexible elastic hinges in accordance with the preferred embodiments of the present invention are also applicable to folding electronic devices that are not portable, such as server computer systems and data storage systems with enclosures having one or more pivoting covers that pivot between a closed configuration for normal operation and an open configuration for maintenance. Thus, while the present invention has been particularly shown and described with reference to preferred embodiments thereof, it will be understood by those skilled in the art that these and other changes in form and details may be made therein without departing from the spirit and scope of the present invention.

What is claimed is:

1. A folding electronic device, comprising:
a first housing body;
a second housing body mounted for pivotal movement relative to the first housing body between a first configuration and a second configuration;
a hollow flexible elastic hinge having a first end fixedly attached to the first housing body and a second end fixedly attached to the second housing body, and wherein the hinge expands as the housing bodies pivot relative to one another toward the first configuration and contracts as the housing bodies pivot relative to one another toward the second configuration.

2. The folding electronic device as recited in claim 1, wherein the housing bodies each include a pivot edge surface about which the housing bodies pivot relative to one another, and wherein the hinge extends over the pivot edge surface of each of the housing bodies.

3. The folding electronic device as recited in claim 2, wherein the hinge contacts the pivot edge surface of each of the housing bodies when the housing bodies are in the first configuration.

4. The folding electronic device as recited in claim 3, wherein the pivot edge surfaces of the housing bodies contact one another when the housing bodies are moving between the first configuration and the second configuration.

5. The folding electronic device as recited in claim 1, further comprising an additional hollow flexible elastic hinge having a first end fixedly attached to the first housing body and a second end fixedly attached to the second housing body, and wherein the additional hinge expands as the housing bodies pivot relative to one another toward the first configuration and contracts as the housing bodies pivot relative to one another toward the second configuration.

6. The folding electronic device as recited in claim 1, further comprising a wire and/or a flexible wiring ribbon extending through the hinge, wherein the wire and/or flexible wiring ribbon is free to slide within the hinge as the hinge expands and contracts in response to the housing bodies pivoting between the first configuration and the second configuration.

7. The folding electronic device as recited in claim 1, wherein the hinge includes an elastic fabric tube.

8. The folding electronic device as recited in claim 1, wherein the housing bodies include a fastening device that releasable retains the housing bodies substantially wall-to-wall in at least one of the first configuration and the second configuration.

9. The folding electronic device as recited in claim 8, wherein the fastening device includes one or more magnets mounted to at least one of the first housing body and the second housing body.

10. The folding electronic device as recited in claim 1, wherein the first housing body and/or the second housing body includes one or more user controls exposed when the housing bodies are in the first position and covered when the housing bodies are in the second position, and wherein the housing bodies are oriented substantially wall-to-wall in both the first configuration and the second configuration.

11. The folding electronic device as recited in claim 1, wherein the first housing body includes one or more user controls and the second housing body includes a display screen, wherein the user controls and the display screen are exposed when the housing bodies are in the first position and covered when the housing bodies are in the second position, and wherein the housing bodies are oriented substantially wall-to-wall in both the first configuration and the second configuration.

12. A folding electronic device, comprising:
a first housing body including one or more user controls;
a second housing body including a display screen and mounted for pivotal movement relative to the first housing body between an open configuration and a closed configuration, wherein the user controls and the display screen are exposed when the housing bodies are in the open configuration and covered when the housing bodies are in the closed configuration, and wherein the housing bodies are oriented substantially wall-to-wall in both the open configuration and the closed configuration;
a hollow flexible elastic hinge having a first end fixedly attached to the first housing body and a second end fixedly attached to the second housing body, and wherein the hinge expands as the housing bodies pivot relative to one another toward the open configuration and contracts as the housing bodies pivot relative to one another toward the closed configuration.

13. The folding electronic device as recited in claim 12, wherein the housing bodies each include a pivot edge surface about which the housing bodies pivot relative to one another, and wherein the hinge extends over the pivot edge surface of each of the housing bodies.

14. The folding electronic device as recited in claim 13, wherein the hinge contacts the pivot edge surface of each of the housing bodies when the housing bodies are in the open configuration.

15. The folding electronic device as recited in claim 14, wherein the pivot edge surfaces of the housing bodies contact one another when the housing bodies are moving between the open configuration and the closed configuration.

16. The folding electronic device as recited in claim 12, further comprising an additional hollow flexible elastic hinge having a first end fixedly attached to the first housing body and a second end fixedly attached to the second housing body, and wherein the additional hinge expands as the housing bodies pivot relative to one another toward the open configuration and contracts as the housing bodies pivot relative to one another toward the closed configuration.

17. The folding electronic device as recited in claim 12, further comprising a wire and/or a flexible wiring ribbon extending through the hinge, wherein the wire and/or flexible wiring ribbon is free to slide within the hinge as the hinge expands and contracts in response to the housing bodies pivoting between the open configuration and the closed configuration.

18. The folding electronic device as recited in claim 12, wherein the hinge includes an elastic fabric tube.

19. The folding electronic device as recited in claim 12, wherein the housing bodies include a fastening device that releasable retains the housing bodies substantially wall-to-wall in at least one of the open configuration and the closed configuration, and wherein the fastening device includes one or more of magnets mounted to at least one of the first housing body and the second housing body.

20. A method of operating a folding electronic device, comprising the steps of:
providing a first housing body and a second housing body mounted for pivotal movement relative to the first housing body by a hollow flexible elastic hinge having a first end fixedly attached to the first housing body and a second end fixedly attached to the second housing body, wherein the housing bodies pivot relative to one another between a first configuration and a second configuration;
expanding the hinge as the housing bodies pivot relative to one another toward the first configuration;
contracting the hinge as the housing bodies pivot relative to one another toward the second configuration.
